(19) United States
(12) Patent Application Publication
(10) Pub. No.: US 2024/0077959 A1
(43) Pub. Date: Mar. 7, 2024

(54) ACTIVE STYLUS HAVING DUAL ELECTRODES

(71) Applicant: RENAISSER TECHNOLOGY CO., LTD., Zhubei City (TW)

(72) Inventors: Yeh Sen-Fan CHUEH, Zhubei city (TW); Tzu-Yu TING, Zhubei City (TW)

(21) Appl. No.: 18/239,074

(22) Filed: Aug. 28, 2023

(30) Foreign Application Priority Data
Sep. 1, 2022 (CN) 202222341383.1

(51) Int. Cl. G06F 3/0354; G06F 3/01; G06F 3/038; G06F 3/041; G06F 3/044

(52) U.S. Cl. CPC G06F 3/03545; G06F 3/016; G06F 3/0383; G06F 3/0414; G06F 3/04164; G06F 3/0448; G06F 2203/04105

(57) ABSTRACT

An active stylus includes a pin holder in a main body housing, a tip shell having non-conductive material, a first electrode having a first end fixed in the tip shell, a second electrode having a first end fixed in the main body housing and a first insulating ring in the second electrode configured for isolating the first electrode. The main body housing includes a first opening and the tip shell includes a second opening and the second opening is opposite to the first opening. Moreover, a second end of the first electrode is protruded through the second opening and a second end of the second electrode is protruded through the first opening. The second end of the first electrode is protruded through the second electrode and detachably fixed in a holding portion of the pin holder; and the second end of the second electrode is detachably fixed in the tip shell.

### TECHNICAL FIELD

The subject matter herein generally relates to an active stylus, and more particularly relates to an active stylus having dual electrodes.

### BACKGROUND

With the development of various electronic devices, many electronic devices, such as smart phones and tablets, use touch panels as operation interfaces. In order to achieve control of these electronic devices, a stylus has emerged as required. The stylus is a pen-shaped tool, and the user can operate the stylus on the touch panel to perform command input to the electronic device.

### SUMMARY

The purpose of the present disclosure is to provide an active stylus having dual electrodes.

To achieve the above purpose, the application provides an active stylus. The active stylus includes a pin holder in a main body housing, a tip shell having non-conductive material, a first electrode having a first end fixed in the tip shell, a second electrode having a first end fixed in the main body housing and a first insulating ring in the second electrode configured for isolating the first electrode. The main body housing includes a first opening and the tip shell includes a second opening and the second opening is opposite to the first opening. Moreover, a second end of the first electrode is protruded through the second opening and a second end of the second electrode is protruded through the first opening. The second end of the first electrode is protruded through the second electrode and detachably fixed in a holding portion of the pin holder; and the second end of the second electrode is detachably fixed in the tip shell.

In some embodiments of the present disclosure, the active stylus further includes a second insulating ring sleeved on an outer peripheral surface of the second electrode. An outer peripheral surface of the second insulating ring abuts against the first opening and the second electrode is then prevent from contacting with the main body housing.

In some embodiments of the present disclosure, the second electrode includes a first cylindrical portion, at the first end, coupled into the main body housing and a second cylindrical portion at the second end. An outer radius of the second cylindrical portion is shorter than an outer radius of the first cylindrical portion and the first cylindrical portion is coaxial with the second cylindrical portion. An annular step is formed at a junction between the first cylindrical portion and the second cylindrical portion.

In some embodiments of the present disclosure, the second cylindrical portion includes a cylindrical conductive portion having a first end coupled to the first cylindrical portion and a cylindrical electrode tip having a first end coupled to a second end of the cylindrical conductive portion. An outer radius of the first end of the cylindrical electrode tip is longer than an outer radius of a second end of the cylindrical electrode tip. A seamless transition is formed from the outer peripheral surface of the first end of the cylindrical electrode tip to the outer peripheral surface of the second end of the cylindrical electrode tip which is formed a slope-shaped outer peripheral surface.

In some embodiments of the present disclosure, the tip shell includes a conical accommodation portion to accommodate the first end of the first electrode. An inner wall surface of a middle section of the conical accommodation portion, along an axial direction, is fit the slope-shaped outer peripheral surface of the cylindrical electrode tip.

In some embodiments of the present disclosure, a first gap is located between a top of the cylindrical electrode tip and the conical accommodation portion. A second gap is located between the first opening and the second opening.

In some embodiments of the present disclosure, the active stylus further includes an inner case, including non-metallic material, fit into the main body housing and a first end of the inner case coupled to the first cylindrical portion to fix the second electrode. A printed circuit board in the inner case is respectively coupled to the first electrode and the second electrode to provide a first transmit signal to the first electrode and a second transmit signal to the second electrode. An end, toward to the tip shell, of a fixer includes a pin holder accommodation portion for accommodating a first end of the pin holder. A holding portion is formed on a second end of the pin holder and is configured to hold the first electrode.

In some embodiments of the present disclosure, the fixer includes a main portion and extension portions respectively located on both sides of the main portion. An end of the main portion includes the pin holder accommodation portion and an opening of the pin holder accommodation portion is toward the tip shell. The fixer is buckled at a predetermined position in the inner case by the extension portions and a buckle structure in the inner case.

In some embodiments of the present disclosure, a force sensor is installed at the bottom of the pin holder accommodation portion.

In some embodiments of the present disclosure, the pin holder includes a stress transferring portion having an accommodation cavity and a ring block on the peripheral surface of the stress transferring portion. The accommodation cavity includes an opening toward the fixer and a concave ring is formed between the peripheral surface of the holding portion, and the peripheral surface of the stress transferring portion is configured to fix a snap ring. An end of a first spring abuts against the bottom of the spring accommodation portion and the other end abuts against the force sensor by a slider. A second spring is sleeved on the peripheral surface on the pin holder and respectively abuts against the ring block and the fixer, wherein a first conductive extension wire is configured to couple to the second spring and the printed circuit board. A third spring is sleeved on the peripheral surface of the stress transferring portion and respectively abuts against a side of the ring block and the snap ring. The other side of the snap ring abuts against an inner wall step of the inner case.

In some embodiments of the present disclosure, the active stylus further includes a fourth spring coupled to the first cylindrical portion and a second conductive extension wire is configured to couple to the fourth spring and the printed circuit board.

In some embodiments of the present disclosure, a second end of the inner case includes external threads and the first cylindrical portion includes internal threads. An outer wall step is formed between the external threads and an area adjacent to the external area. The first end of the inner case is screwed to the first cylindrical portion through the external threads and the internal threads.

In some embodiments of the present disclosure, the main body housing is made of metallic material.

In some embodiments of the present disclosure, the main body housing is coupled to the ground terminal of the internal circuit board.

In some embodiments of the present disclosure, the main body housing includes a vibrator.

It should be understood that the description in the section is not intended to identify key or important features of embodiments of the present disclosure, nor is it intended to limit the scope of the present disclosure. Other features of the present disclosure will be readily understood from the following specification.

### BRIEF DESCRIPTION OF THE DRAWINGS

In the accompanying drawings, unless otherwise specified, the same reference numerals throughout multiple accompanying drawings indicate the same or similar parts or elements. These accompanying drawings are not necessarily drawn to scale. It should be understood that these accompanying drawings depict only some embodiments disclosed in accordance with the present disclosure and should not be considered as limiting the scope of the present disclosure.

FIG. 1 is a schematic view of an active stylus of one embodiment the present disclosure;

FIG. 2 is a schematic explosion view of a portion of an active stylus of one embodiment of the present disclosure;

FIG. 3 is a schematic explosion views of a portion of an active stylus of one embodiment of the present disclosure;

FIG. 4 is a schematic explosion view of a portion of one embodiment of the present disclosure;

FIG. 5 is a schematic explosion view of a portion of one embodiment of the present disclosure;

FIG. 6 is a schematic explosion view of a portion of an active stylus of one embodiment of the present disclosure; and

FIG. 7 is a schematic explosion view of a portion of an active stylus of one embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other words that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

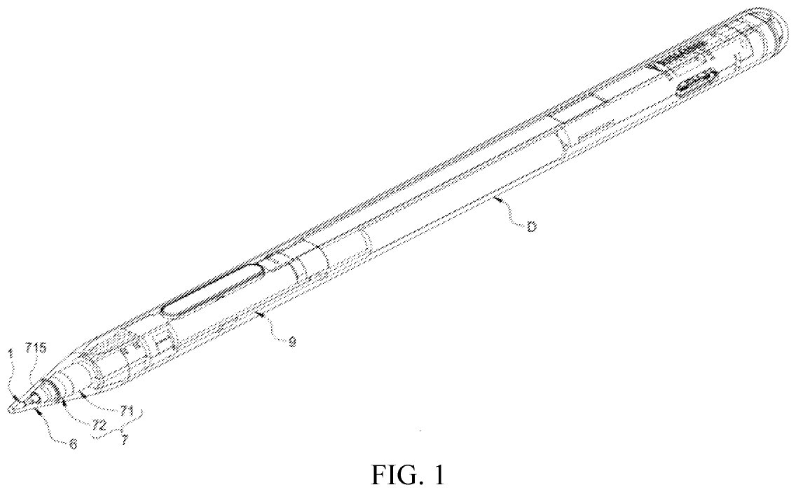

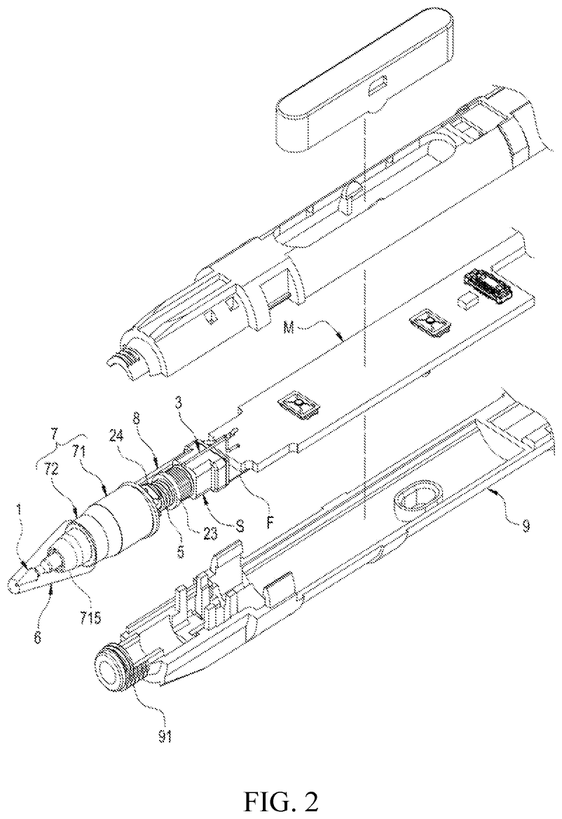

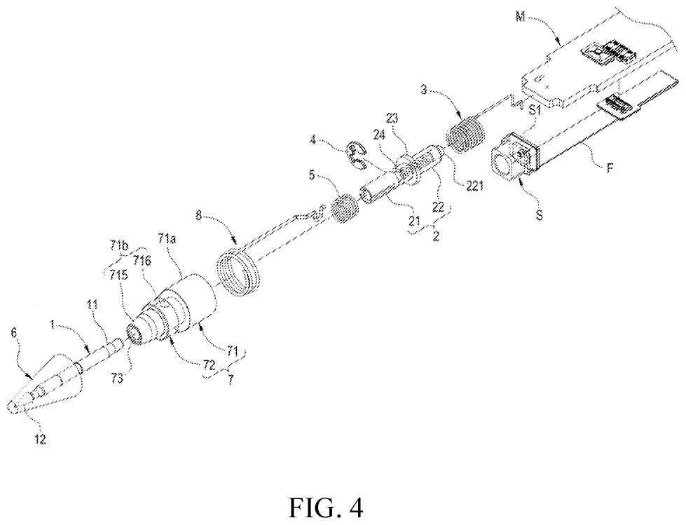

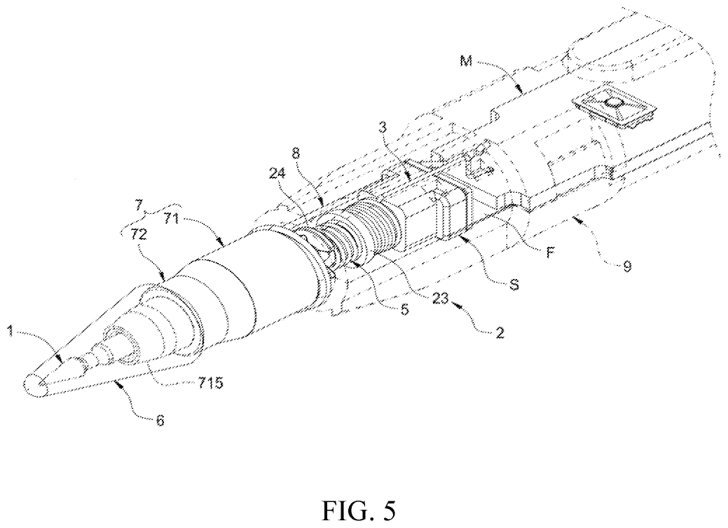

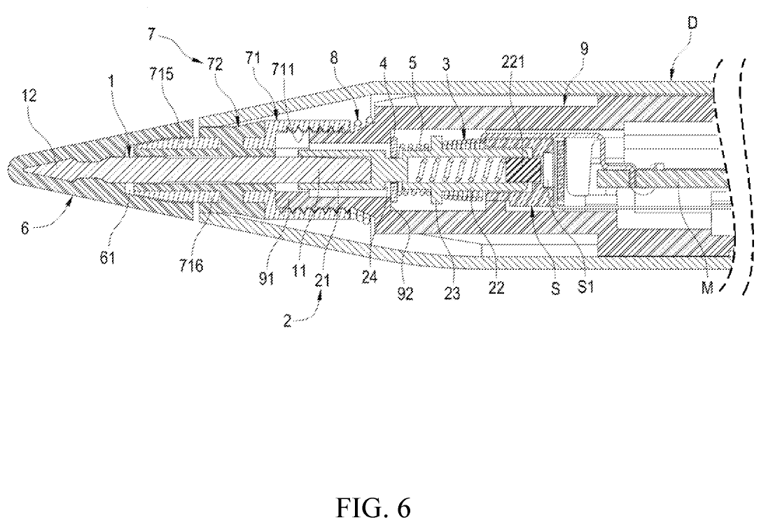

As shown in FIGS. 1 to 7, the present disclosure provides an active stylus having dual electrodes. The active stylus includes a main body housing D, a tip shell 6, a first electrode 1 and a second electrode 7. In some embodiments, the main body housing D includes a first opening and a pin holder 2 is in the main body housing D. The tip shell 6 includes non-conductive material and a second opening. A first end of the first electrode 1 is fixed in the tip shell 6. A second end of the first electrode 1 is protruded through the second opening of the tip shell 6. In this embodiment, a first insulating ring 73 in the second electrode 7 is configured for isolating the first electrode 1. In this embodiment, the first insulating ring 73 is sleeved on the first electrode 1. A first end of the second electrode 7 is fixed in the main body housing D and the second end of the second electrode 7 is protruded through the first opening. The second end of the first electrode 1 is protruded through the second electrode 7 and detachably fixed in a holding portion 21 of the pin holder 2 and the second end of the second electrode 7 is detachably fixed in the tip shell 6. Moreover, the second electrode 7, in some embodiments, is a cylindrical electrode.

As shown in FIG. 1, the second end of the second electrode 7 is located in the tip shell 6. The main body housing D and the tip shell 6 constitute the overall appearance of the stylus, which simplicity of the stylus having dual electrodes. Moreover, since the second electrode 7 is not exposed to the air, the service life of the second electrode 7 is then extended.

The first electrode 1 and the tip shell 6 are easily damaged due to long-term pressing or physical friction in the use environment. Therefore, in this embodiment, the second end of the first electrode 1 is detachably fixed in the holding portion 21 of the pin holder 2. The second end of the second electrode 7 is detachably fixed in the tip shell 6. In this embodiment, the second electrode 7 is detached from the holding portion 21 under the action of external force, and the second electrode 7 is then detached from the main body housing D. Similarly, the second electrode 7 is detached from the tip shell 6. Therefore, the tip shell 6 and the first electrode 1 are easy to be replaced.

As shown in FIG. 1, the main body housing D includes a hollow straight portion and a hollow conical portion. The hollow conical portion is shrunk toward the tip shell 6 and an end, away from the hollow straight portion, of the hollow conical portion is formed a first opening. The tip shell 6, in this embodiment, includes a frustum-shaped housing and a second opening is formed at the bottom of the frustum-shaped housing. The first opening of the hollow conical portion is adapted to the second opening of the frustum-shaped housing. Therefore, a large conical structure is formed by the tip shell 6 and the hollow conical portion and a neat pen-shaped appearance is then provided.

The first electrode 1 of the active stylus of the present disclosure is configured to transmit a first transmit signal and the second electrode 7 is configured to transmit a second transmit signal. The frequency of the first transmit signal is different from the frequency of the second transmit signal. The signals are transmitted to an electronic apparatus with a touch control panel, e.g. tablets, while the active stylus is applied on the electronic apparatus. The electronic apparatus is then capable of determining the position of the active stylus on the touch control panel, tilt of the active stylus and other information of the active stylus in response to the received signals.

In this embodiment, the tip shell 6 includes non-conductive material, e.g., rubber or silicone which will not affect the signal transmission of the first electrode 1 and the second electrode 7.

In some embodiments, the active stylus further includes a second insulating ring 72 and the second electrode 7 is sleeved in the second insulating ring 72. The outer peripheral surface of the second insulating ring 72 abuts against the first opening and the second electrode 7 does not contact the main body housing D. Therefore, the second electrode 7 is firmly held without moving in the main body housing D.

In some embodiments, the main body housing D includes metal material. Since the second electrode 7 does not contact the main body housing D, in this embodiment, the electrical signal of the second electrode 7 will not flow to the ground via the main body housing D and human body.

In some embodiments, the first insulating ring 73 and the second insulating ring 72 are integrally formed. During injection molding, the liquid insulating material flows to the outer peripheral surface and the inner wall of the second electrode 7 via openings on the wall surface of the second electrode 7 at the same time. Therefore, the first insulating ring 73 and the second insulating ring 72 are more firmly fixed on the second electrode 7. In some other embodiments, the first insulating ring 73 and the second insulating ring 72 are manufactured respectively.

In some embodiments, the second electrode 7 includes a first cylindrical portion 71a and a second cylindrical portion 71b. The first cylindrical portion 71a is used to firmly hold the first end of the second electrode 7 in the main body housing D. The second cylindrical portion 71b is coaxial with the first cylindrical portion 71a. The outer radius of the second cylindrical portion 71b is shorter than the outer radius of the first cylindrical portion 71a. An annular step is formed at the junction between the first cylindrical portion 71a and the second cylindrical portion 71b. The second insulation ring 72 is sleeved on an outer peripheral surface 71b2 of the second cylindrical portion 71b. A first end of the second insulation ring 72 abuts against the annular step and a second end of the second insulation ring 72 abuts against the first opening. Therefore, the second insulation ring 72 is firmly held at the first opening and the first cylindrical portion 71a has no contact with the main body housing D.

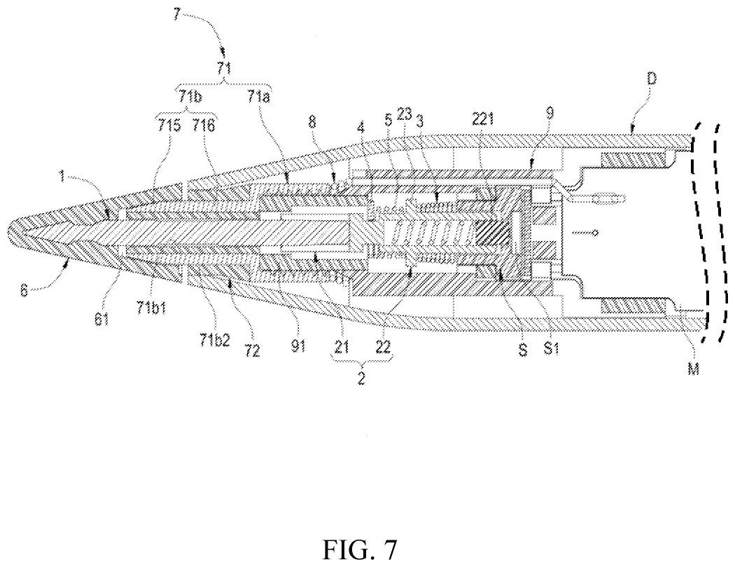

As shown in FIG. 7, an inner surface 71b1 of the second cylindrical portion 71b is sleeved on an outer peripheral surface of the first insulating ring 73. The inner radius of the second cylindrical portion 71b is shorter than the inner radius of the first cylindrical 71a.

Therefore, a portion of the second electrode 7 is in the main body housing D and the other portion of the second electrode 7 is in the tip shell 6. The second electrode 7 is also insulated from the main body housing D and the first electrode 1. Moreover, since the second insulating ring 72 is firmly held at the first opening and abuts against the annular step, the second electrode 7 is prevented from loosening in the direction of the tip shell 6.

Furthermore, the second cylindrical portion 71b includes a cylindrical electrode tip 715 and a cylindrical conductive portion 716. The cylindrical conductive portion 716 includes a first end coupled to the first cylinder 71a and a second end coupled to a first end of the cylindrical electrode tip 715. The outer radius of the first end of the cylindrical electrode tip 715 is longer than the outer radius of the second end of the cylindrical electrode tip 715. A seamless transition from the outer peripheral surface of the first end of the cylindrical electrode tip 715 to the outer peripheral surface of the second end of the cylindrical electrode tip 715 is to form a slope-shaped outer peripheral surface.

The tip shell 6, in some embodiments, includes an inner frustum receiving portion 61. An apex of the inner frustum receiving portion 61 is used to wrap the first end of the first electrode 1. The inner wall located at the middle portion of the inner frustum receiving portion 61 is abutted with the slope-shaped outer peripheral surface of the cylindrical electrode tip 715. Therefore, in this embodiment, the cylindrical tip 715 is firmly held in the tip shell 6 and the tip shell 6 is moved along the direction of the axis of the active stylus. Furthermore, the outer peripheral surface of the cylindrical electrode tip 715 is a slope-shaped outer peripheral surface, the wireless signal of the second electrode 7 is effectively transmitted.

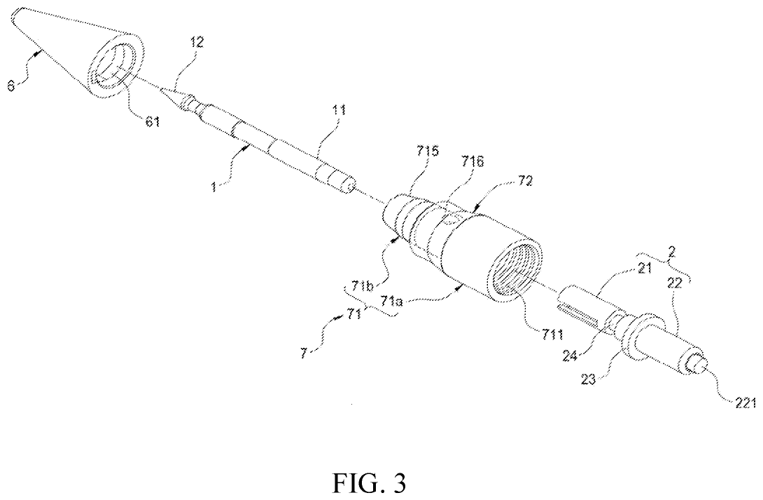

AS shown in FIGS. 3, 4 and 6, the first end of the first electrode 1 includes an arrow shape structure which allows the wireless signal, transmitted by the first electrode 1, is effectively transmitted and the first electrode 1 is firmly held in the tip shell 6. In this embodiment, the second end of the second electrode 7 includes a cylindrical structure 11 held in the holding portion 21.

In some embodiments, a first gap is located between the tip head of the cylindrical electrode tip 715 and the frustum receiving portion 61. Moreover, a second gap is located between the first opening and the second opening. Therefore, with the buffer space provided by the first gap and the second gap, the damage probability of a force sensor of the active stylus will be greatly decreased.

In some embodiments, the active stylus further includes an inner case 9 which is made of non-metal material. The inner case 9 is firmly held in the main body housing D. A first end of the inner case 9 is coupled to the first cylindrical portion 71a to firmly held the second electrode 7. The printed circuit board (M, F), a fixer S for holding the pin holder 2, the pin holder 2 are located in the inner case 9. The printed circuit board M is electrically coupled to the first electrode 1 and the second electrode 7. The printed circuit board M provides the first transmit signal to the first electrode 1 and the second transmit signal to the second electrode 7. An end of the fixer S, toward the tip shell 6, includes an accommodation portion. A first end of the pin holder 2 is accommodated in the accommodation portion and a second end of the pin holder 2 is used for holding the first electrode 1.

In some embodiments, the main body housing D is made of metal material. Since the inner case 9 is made of non-metal material, the conductive components in the inner case 9 are insulated from the main body housing D. In this embodiment, the metal material includes copper, aluminum, stainless steel, aluminum alloy and titanium alloy.

The fixer S includes a main body portion and an extension portion. An end of the main body of the fixer S includes the accommodation portion and an opening of the accommodation portion is toward the tip shell 6. The extension portion of the fixer S are respectively located on both sides of the main body portion of the fixer S. The extension portion is used to work with the buckle structure in the inner case 9. The fixer S is then arranged at a predetermined location in the inner case 9. Therefore, with the main body portion and the extension portion of the fixer S, the fixer S is then firmly fixed in the inner case 9. Since the accommodation portion holds the pin holder 2, the pin holder 2 only slightly moves along the direction of the active stylus.

Furthermore, a force sensor Si is located at the bottom of the accommodation portion. When the tip shell 6 is pressed on a touch screen of an external electronic apparatus, the first electrode 1 moves relatively along the axial direction of the active stylus, the pin holder 2 is then driven to move relatively along the axial direction of the active stylus. Therefore, the force sensor Si is then pressed and a stress is then generated. The stress is then sensed by the force sensor Si and a sensing signal is generated in response to the sensed stress. The sensing signal is then transformed to a wireless signal transmitted to the external electronic apparatus with the touch screen. The information will be displayed on the touch screen in response to the received wireless signal.

In some embodiments, the pin holder 2 includes a stress transferring portion 22, a holding portion 21, a first spring (not shown), a second spring 3 and a third spring 5. The stress transferring portion 22, in this embodiment, includes an accommodation cavity having an opening toward the fixer S and a ring block 23. A concave ring 24 is formed between the peripheral surface of the stress transferring portion 22 and the peripheral surface of the holding portion 21. A snap ring 4 is fixed on the concave ring 24. An end of a first spring abuts against the bottom on the accommodation cavity. The other end of the first spring abuts a slider 221 and the slider 221 abuts against the force sensor Si. A second spring 3 is sleeved on the peripheral surface of the stress transferring portion 22 and respectively abuts against the ring block 23 and the fixer S. Moreover, the second spring 3 includes a first extension wire coupled to the printed circuit board M. A third spring 5 is sleeved on the peripheral surface of the stress transferring portion 22 and respectively abuts against the ring block 23 and the snap ring 4. A side of the snap ring 4 abuts against the third spring 5, and the other side of the snap ring 4 abuts against a step 92 at the inner wall of the inner case 9.

When the active stylus is in service, the first electrode 1 is pressed, a stress is generated and is transferred, via the first electrode 1, the holding portion 21 and the stress transferring portion 22, and along the axis of the active stylus to compress the first spring. Therefore, the stress is then transferred to the force sensor Si via the slider 221. The second spring 3 is always in a pre-compression state to ensure the second spring 3 is physically contact with the ring block 23. Moreover, since the second spring 3 is always in the pre-compression state, the slider 221 is then always contact with the force sensor S 1. In some embodiments, the slider is always kept contacting or close to the force sensor S 1. Furthermore, with the pin holder 2 of the present disclosure, the stress caused by the user's writing press is effectively sensed and the electronic signal transmitted from the printed circuit board M is then surely transmitted.

In some embodiments, the active stylus of the present disclosure further includes a fourth spring 8 physically contact with the first cylindrical portion 71a. The fourth spring 8 includes a second extension wire coupled to the printed circuit board M.

In some embodiments, a second end of the inner case 9 includes external threads 91. A step is formed between the external threads 91 and area adjacent the external threads 91 on the external surface of the inner case 9. Moreover, the first cylindrical portion 71a includes internal thread 711. Therefore, the second end of the inner case 9 is screwed in the first cylindrical portion 71a with the external thread 91 and the internal thread 711. The fourth spring 8 is sleeved on the external surface of the inner case 9 and respectively abuts against the first cylindrical portion 71a and the step formed between the external thread 91 and the area adjacent the external thread 91 on the external surface of the inner case 9. The fourth spring 4 is always in a compression state to ensure the fourth spring 4 is physically contact with the second cylindrical portion 71b and the electronic signal transmitted from the printed circuit board M is then surely transmitted. Moreover, with the inner case 9 and the thread structure, the second electrode 7 is firmly fixed.

In some embodiments, the main body housing D is made of metal material which provides functions of signal shielding.

In some embodiments, the main body housing D is electrically connected to the ground terminal of the internal circuit board to form a loop.

In some embodiments, the active stylus further includes a vibrator which can improve the user experience and increase the fun of use.

In some embodiments, the active stylus further includes other components such as batteries, magnets, buttons, lights, etc.

The following is a signal transmission method of the active stylus of one embodiment of the present disclosure. A first transmit signal is transmitted from the printed circuit board M to the first electrode 1 via the second spring 3 and the pin holder 2. The first transmit signal is transformed to a first wireless signal and the first wireless signal is then emitted by the first end 12 of the first electrode 1. A second transmit signal is transmitted from the print circuit board M to the second electrode 7 via the fourth spring 8. The second transmit signal is transformed to a second wireless signal and the second wireless signal is then emitted by the second end, the cylindrical electrode tip 715, of the second electrode 7.

In some embodiments, the tip shell 6 is made of non-conductive material. In some embodiments, the main body housing D is made of metal material and the inner shell 9 is made of non-metal material. In some embodiments, the fixer S is made of non-metal material and the ground terminal of the printed circuit board (M and F) is connected to the main body housing D.

The embodiments shown and described above are only examples and do not limit the patent scope of the disclosure. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An active stylus, comprising:
a pin holder in a main body housing, wherein the main body housing includes a first opening;
a tip shell having non-conductive material, wherein the tip shell includes a second opening and the second opening is opposite to the first opening;
a first electrode having a first end fixed in the tip shell and a second end protruded through the second opening;
a second electrode having a first end fixed in the main body housing and a second end protruded through the first opening; and
a first insulating ring in the second electrode configured for isolating the first electrode;
wherein the second end of the first electrode is protruded through the second electrode and detachably fixed in a holding portion of the pin holder; and
wherein the second end of the second electrode is detachably fixed in the tip shell.

2. The active stylus of claim 1 further including a second insulating ring sleeved on an outer peripheral surface of the second electrode, wherein an outer peripheral surface of the second insulating ring abuts against the first opening and the second electrode is then prevent from contacting with the main body housing.

3. The active stylus of claim 2, wherein the second electrode includes a first cylindrical portion, at the first end, coupled into the main body housing and a second cylindrical portion at the second end, wherein an outer radius of the second cylindrical portion is shorter than an outer radius of the first cylindrical portion and the first cylindrical portion is coaxial with the second cylindrical portion and wherein an annular step is formed at a junction between the first cylindrical portion and the second cylindrical portion.

4. The active stylus of claim 3, wherein the second cylindrical portion includes a cylindrical conductive portion having a first end coupled to the first cylindrical portion and a cylindrical electrode tip having a first end coupled to a second end of the cylindrical conductive portion and wherein an outer radius of the first end of the cylindrical electrode tip is longer than an outer radius of a second end of the cylindrical electrode tip and a seamless transition formed from the outer peripheral surface of the first end of the cylindrical electrode tip to the outer peripheral surface of the second end of the cylindrical electrode tip is formed a slope-shaped outer peripheral surface.

5. The active stylus of claim 1, wherein the tip shell includes a conical accommodation portion to accommodate the first end of the first electrode and an inner wall surface of a middle section of the conical accommodation portion, along an axial direction, is fit the slope-shaped outer peripheral surface of the cylindrical electrode tip.

6. The active stylus of claim 5, wherein a first gap is located between a top of the cylindrical electrode tip and the conical accommodation portion and a second gap is located between the first opening and the second opening.

7. The active stylus of claim 3 further including an inner case, including non-metallic material, fit into the main body housing and a first end of the inner case coupled to the first cylindrical portion to fix the second electrode, wherein a printed circuit board in the inner case is respectively coupled to the first electrode and the second electrode to provide a first transmit signal to the first electrode and a second transmit signal to the second electrode and wherein an end, toward to the tip shell, of a fixer includes a pin holder accommodation portion for accommodating a first end of the pin holder, wherein a holding portion is formed on a second end of the pin holder and is configured to hold the first electrode.

8. The active stylus of claim 7, wherein the fixer includes a main portion and extension portions respectively located on both sides of the main portion, wherein an end of the main portion includes the pin holder accommodation portion and an opening of the pin holder accommodation portion is toward the tip shell, and the fixer is buckled at a predetermined position in the inner case by the extension portions and a buckle structure in the inner case.

9. The active stylus of claim 7, wherein a force sensor is installed at the bottom of the pin holder accommodation portion.

10. The active stylus of claim 7, wherein the pin holder includes:
a stress transferring portion having an accommodation cavity and a ring block on the peripheral surface of the stress transferring portion, wherein the accommodation cavity includes an opening toward the fixer and a concave ring is formed between the peripheral surface of the holding portion, and the peripheral surface of the stress transferring portion is configured to fix a snap ring;
an end of a first spring abuts against the bottom of the spring accommodation portion and the other end abuts against the force sensor by a slider;
a second spring is sleeved on the peripheral surface on the pin holder and respectively abuts against the ring block and the fixer, wherein a first conductive extension wire is configured to couple to the second spring and the printed circuit board; and
a third spring is sleeved on the peripheral surface of the stress transferring portion and respectively abuts against a side of the ring block and the snap ring;
wherein the other side of the snap ring abuts against an inner wall step of the inner case.

11. The active stylus of claim 7 further including a fourth spring coupled to the first cylindrical portion and a second conductive extension wire is configured to couple to the fourth spring and the printed circuit board.

12. The active stylus of claim 7, wherein a second end of the inner case includes external threads and the first cylindrical portion includes internal threads, wherein an outer wall step is formed between the external threads and an area adjacent to the external area and wherein the first end of the inner case is screwed to the first cylindrical portion through the external threads and the internal threads.

13. The active stylus of claim 1, wherein the main body housing is made of metallic material.

14. The active stylus of claim 13, wherein the main body housing is coupled to the ground terminal of the internal circuit board.

15. The active stylus of claim 1, wherein the main body housing includes a vibrator.
